(19) United States
(12) Patent Application Publication
(10) Pub. No.: US 2018/0090016 A1
(43) Pub. Date: Mar. 29, 2018

(54) METHODS AND APPARATUS TO NAVIGATE DRONES BASED ON WEATHER DATA

(71) Applicant: Intel Corporation, Santa Clara, CA (US)

(72) Inventors: Yoshifumi Nishi, Beaverton, OR (US); David W. Browning, Beaverton, OR (US)

(21) Appl. No.: 15/277,747

(22) Filed: Sep. 27, 2016

(51) Int. Cl. G08G 5/00; G05D 1/10; G05D 1/00; B64C 39/02

(52) U.S. Cl. CPC G08G 5/0039; G05D 1/101; G08G 5/0091; G08G 5/0069; B64C 39/024; G05D 1/0088

(57) ABSTRACT

Methods and apparatus to adjusting a flight path of a drone based on weather data are disclosed herein. An example apparatus includes navigating, via a processor of a drone, according to a flight path; intercepting, via the processor of the drone, weather data identified by a weather source within a threshold range of the flight path; and when the weather data corresponds to undesirable weather data, adjusting, via the processor of the drone, the flight path to avoid a region corresponding to the weather source.

### FIELD OF THE DISCLOSURE

This disclosure relates generally to drones, more particularly, to methods and apparatus to navigate drones based on weather data.

### BACKGROUND

Unmanned aerial vehicles, such as drones, are aircrafts that receive or generate navigational paths to travel from a first location to a second location without a pilot on board. Drones have sophisticated on-board systems that allow the drones to travel autonomously and/or via remote control. Recently, drones have increased in popularity expanding from military application to commercial, recreational, and other applications.

### BRIEF DESCRIPTION OF THE DRAWINGS

FIG. 1 illustrates an example drone navigating through an environment based on weather data identified by local weathering stations.

FIG. 2 illustrates an example map of a navigational path and an adjusted navigational path for the example drone of FIG. 1.

FIG. 3 is a block diagram of an example navigational path determiner of FIG. 1.

FIG. 4 is a block diagram of an example on-board controller of FIG. 1.

FIG. 5 is a flowchart representative of example machine readable instructions that may be executed to implement the example navigational path determiner of FIGS. 1 and/or 3 to generate a navigational path for the example drone of FIG. 1.

FIG. 6 is a flowchart representative of example machine readable instructions that may be executed to implement the example navigational path determiner of FIGS. 1 and/or 3 to adjust a navigational path for the example drone of FIG. 1.

FIG. 7 is a flowchart representative of example machine readable instructions that may be executed to implement the example on-board controller FIGS. 1 and/or 4 to adjust a navigational path for the example drone of FIG. 1.

FIG. 8 is a flowchart representative of example machine readable instructions that may be executed to implement the example on-board controller FIGS. 1 and/or 4 to warn a user of potential danger regions of flight.

FIG. 9 is a block diagram of an example processor platform that may be utilized to execute the example instructions of FIGS. 5-6 to implement the example dimension determiner of FIGS. 1 and/or 2.

FIG. 10 is a block diagram of an example processor platform that may be utilized to execute the example instructions of FIGS. 7-8 to implement the example drone controller of FIGS. 1 and/or 4.

The figures are not to scale. Wherever possible, the same reference numbers will be used throughout the drawing(s) and accompanying written description to refer to the same or like parts.

### DETAILED DESCRIPTION

Unmanned aerial vehicles, such as drones, have recently increased in popularity with the decrease in the price of such aerial vehicles. Although drones were originally designed for military applications, the application of drones has expanded to surveillance, photography, agriculture, racing, delivery, and various other applications. Drones may be controlled by a user using a remote control, by instructions from a base station, and/or autonomously via on-board computers. Unlike jet airliners, drones are typically flown at lower altitudes (e.g., altitudes below the weather). Also unlike jet airlines, drones are typically not weather resistant. Weather conditions such as rain, snow, sleet, hail, and/or high wind speeds can cause the drone to crash and/or become damaged. In some examples, weather patterns may quickly change. Additionally, weather patterns may be highly localized. For example, large buildings may create vastly different wind speeds within a small area (e.g., blocks). To avoid damage to drones, drones must dynamically adjust to changing and localized weather patterns to avoid undesirable weather conditions.

Conventional techniques of controlling drones may utilize a base station to analyze weather forecast information to determine and/or adjust a flight path to provide a safe flight path for the drone. Such conventional techniques transmit the flight path and/or send updated flight paths to the drone when necessary. However, such conventional techniques can only analyze weather forecast information from weather sources connected to a network leaving blind spots during navigation. Additionally, when the drone losses contact with the base station, the drone will not be able to receive weather and/or flight path updates using such conventional techniques. Additionally, such conventional techniques apply to autonomous drone flight and do not account for user control of the drone.

Examples disclosed herein alleviate the problems associated with such conventional techniques by utilizing the drone to intercept weather data from local weather sources (e.g., weather stations) directly to identify danger regions locally (e.g., regions that include undesirable weather, natural disasters, or no fly zones). In this manner, the drone can identify changes in weather patterns directly independent of a base station. In some examples, the drone may intercept weather data identified by a user on a device (e.g., a computer, a mobile device, a cellular device, a tablet, etc.) Additionally, because example disclosed herein may gather weather data that may be unreachable by a base station, examples disclosed herein determine weather patterns with a higher granularity that conventional techniques, thereby providing better protection for the drone.

Examples disclosed herein include a drone with an on-board controller to intercept wirelessly transmitted weather data from local weather sources as the drone is navigation to a target location, allowing the drone to track upcoming weather that may be lacking from a remote base station. Examples disclosed herein provide greater protection than conventional navigation techniques because examples disclosed herein do not require communication with a remote base station. Rather, examples disclosed herein intercept wirelessly transmitted weather data from upcoming weather sources (e.g., within a threshold range of the current flight path) to verify that the current flight path is safe to travel through. Examples disclosed herein adjust (e.g., reroute) a flight plan when the drone determines that the current flight path will lead to a danger region. In some examples, such as when the drone is being controlled remotely by a user, the drone may send a warning signal to the user identifying the danger region. Additionally or alternatively, examples disclosed herein may override user control when the current navigational path is heading toward an identified danger region. As used herein, flight path and navigational path are used interchangeably and are defined as the path that a drone travels on to reach a target location.

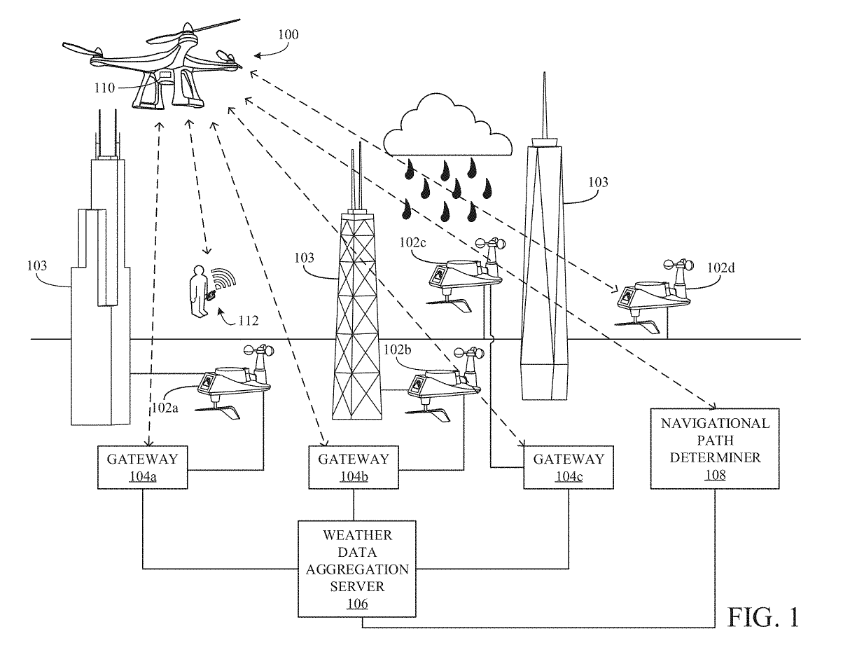

FIG. 1 illustrates an example drone 100 navigating through an environment based on weather data received from example weather stations 102a-d. The example environment of FIG. 1 includes the example drone 100, the example weather stations 102a-d, example structures 103, example gateways 104a-c, an example weather data aggregation server 106, an example navigational path determiner 108, and an example user 112.

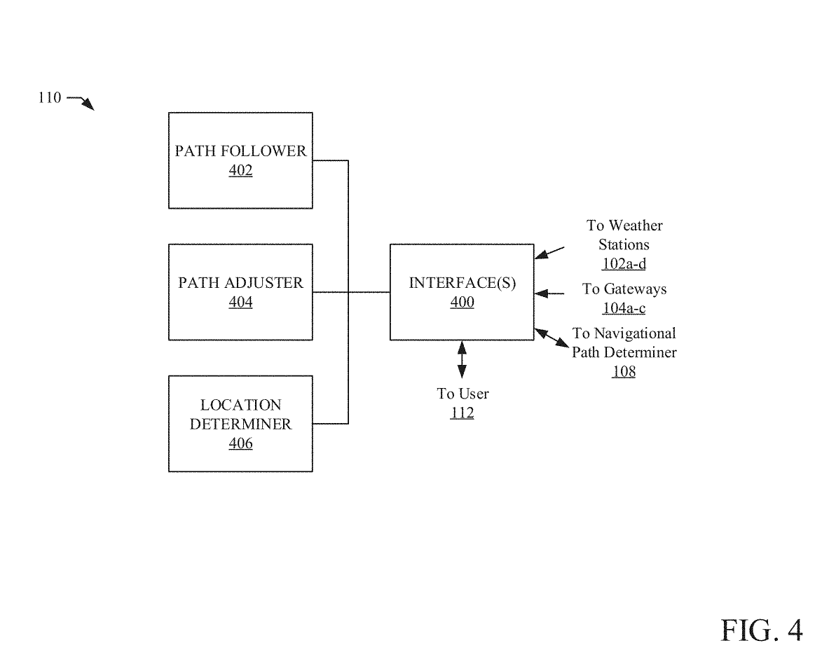

The example drone 100 of FIG. 1 is an unmanned aerial vehicle (UAV) that operates without a human pilot on board. The example drone 100 may be controlled to fly from a first location to a second location. The example drone 100 may be controlled by instructions from the example user 112 (e.g., via a remote control) and/or from the example navigational path determiner 108. Alternatively, as further described in conjunction with FIG. 4, the example drone 100 may be controlled autonomously via the example on-board controller 110. As further described below, the example drone 100 intercepts local weather data from the example weather stations 102a-d and/or the example gateways 104a-c to adjust a navigational (e.g., flight) path and/or warn the example user 112 of a danger region of flight. In some examples, the example drone 100 may include one or more sensors that can detect weather conditions and/or wind speeds as the drone travels. In such examples, the example drone 100 may transmit the weather conditions and/or wind speeds with location data to the example weather data aggregation server 106 and/or the example navigational path determiner 108 via a network communication. In this manner, the weather data aggregation server 106 and/or the example navigational path determiner 108 may have additional weather patterns to generate navigational paths for other drone that may or may not include such sensors.

The example weather stations 102a-d of FIG. 1 are crowd-sourced devices (e.g., weather sources) that measure and communicate weather data. The weather data may include temperature, relative humidity, pressure, rain fall, snow fall, hail, wind speed, wind direction, etc. The example weather stations 102a-d may be personal weather stations, commercial weather stations, independent weather stations, digital rain gauges, irrigation soil sensors, digital anemometers, and/or any other device capable of measuring weather data. Additionally or alternatively, the example weather satiations 102a-d may be computing devices (e.g., laptops, mobile devices, tablets, etc.) that identify weather data. In such examples, the weather data may be identified (e.g., entered) by a user on the computed device and/or the computing device may include sensors that measure weather data. In some examples, the example weather stations 102a, b are attached to a building and/or other structure. In some examples, the example weather stations 102c, d are planted in the ground. Alternatively, the example weather stations 102a, b may be placed in any location and/or may be mobile (e.g., handheld).

In the illustrated example of FIG. 1, the weather data identified by the example weather stations 102b, c include rain and the weather data identified (e.g., measured or received) by the example weather stations 102a, d do not include rain. In some examples, the weather stations 102a-c communicate (e.g., using a beacon or other communication device) the measured/identified weather data to the example gateways 102a-c and/or any other device via a wired or wireless network communication (e.g., via a cellular network, a Bluetooth network, a Wi-Fi network, the Internet, etc.). In some examples, the weather station 102d, may measure weather data and transmit weather data directly to a user without sending the weather data to the example gateways 102a-c. In some examples, the weather station 102d includes a gateway to transmit the weather data to a server (e.g., the example weather data aggregation server 106).

The example structures 103 of FIG. 1 are objects that may impede the flight of the example drone 100. In the illustrated example of FIG. 1, the structures 103 are buildings. Alternatively, the structures 103 may be houses, trees, rocks, billboards, hills, towers, antennas, power lines, and/or any other structure that may impede the flight of the example drone 100.

The example gateways 104a-c of FIG. 1 receive the weather data from the example weather stations 102a-c and/or from the example drone (e.g., via a sensor). The example gateways 104a-c provide a network point to access the example weather data aggregation server 106 via a network (e.g., cellular network, Wi-Fi network, the Internet etc.). The example gateways 104a-c provide the weather data aggregation server 106 with the weather data identified by the example weather stations 102a-c. The example gateways 104a-c provide location data (e.g., coordinates) and/or weather station identifiers to the example weather data aggregation server 106. The location data identifies the region corresponding to the example weather stations. In some examples, the gateways 104a-c aggregate and distribute crowd-sourced data from computing devices (e.g., computers, mobile devices, tablets, etc.). For example, a mobile device may prompt a user to enter weather data based on a current location of a user (e.g., based on a positioning system of the mobile device). In such an example, the weather data and the location data me aggregated and distributed by the example gateways 104a-c. Additionally, the example gateways 104a-c may beacon, or otherwise provide a network communication, to allow other devices (e.g., such as the example drone 100) to communicate with the example gateways 104a-c to receive the weather data, the location data, the weather station identifiers, and/or any other data corresponding to the weather stations 102a-d and/or gateways 104a-c. The example weather data aggregation server 106 continuously aggregates the weather data from all gateways 102a-c and/or weather station(s) 102d to identify highly granular localized (e.g., crowd-sourced) weather data for a region. In some examples, the weather data aggregation server 106 may identify natural disasters and/or other dynamically updated no fly zones. In this manner, the weather data aggregation server 106 may aggregate such data so that the example drone 100 avoids such regions.

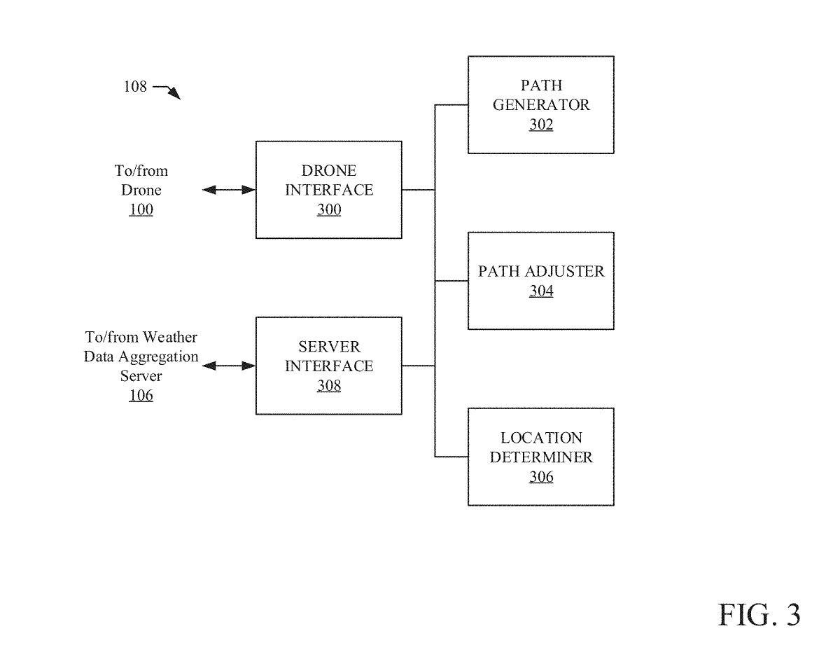

The example navigational path determiner 108 of FIG. 1 receives the aggregated weather data from the example weather data aggregation server 106. Additionally, the example navigational path determiner 108 may receive natural disaster and/or other dynamically updated no fly zones from the example weather data aggregation server 106. The example navigational path determiner 108 is a remote device (e.g., station) that may transmit instructions (e.g., navigational paths) to the example drone 100 via a wireless communication. In some examples, the navigational path determiner 108 generates a navigational path from a first location to a second location and transmits the navigational path to the example drone 100. In such examples, the navigational path determiner 108 may adjust, prior to transmitting to the example drone 100, the optimal (e.g., fastest, closest, etc.) navigational path based on the aggregated weather data to avoid danger regions. For example, the navigational path determiner 108 may adjust an optimal navigational path to avoid flying within a threshold range of the location of weather stations 102b, c, because the example weather stations 102b, c are identifying rain in the region. In some examples, the navigational path determiner 108 monitors the navigational path being followed by the example drone 100 to identify any changes in weather that may correspond to a danger region. In such examples, the navigational path determiner 108 may adjust a navigational path (e.g., a previously transmitted navigational path) to avoid danger regions. The example navigational path determiner 108 is further described in conjunction with FIG. 3.

The example drone 100 of FIG. 1 includes the example on-board controller 110. The example on-board controller 110 receives navigational plans (e.g., pre-flight and/or adjusted) from the example navigational path determiner 108 and/or the example user 112. The example on-board controller 110 controls the flight of the example drone 100 based on the navigational plans. Additionally, the example on-board controller 110 intercepts weather data from the example weather stations 102a-d and/or gateways 102a-c and determines danger regions based on the intercepted weather data. The example on-board controller 110 may adjust the navigational path, override manual control, and/or warn the example user 112 based on the danger regions. The example on-board controller 110 is further described in conjunction with FIG. 4.

In some examples, the example user 112 of FIG. 1 may provide flight instructions (e.g., a navigational path) to the example drone 100. In such examples, the user 112 may have a remote control to communicate the flight instructions to the example drone 100. When the example user 112 is instructing the drone 100 to fly into a danger region, the example on-board controller 110 may transmit a warning to the example user 112 via the remote control that the current path leads to a danger region. In some examples, the on-board controller 110 may also provide alternative paths that do not include the danger region. Alternatively, the example on-board controller 110 may override the manual control of the example user 112 to navigate the drone 100 to a safe region.

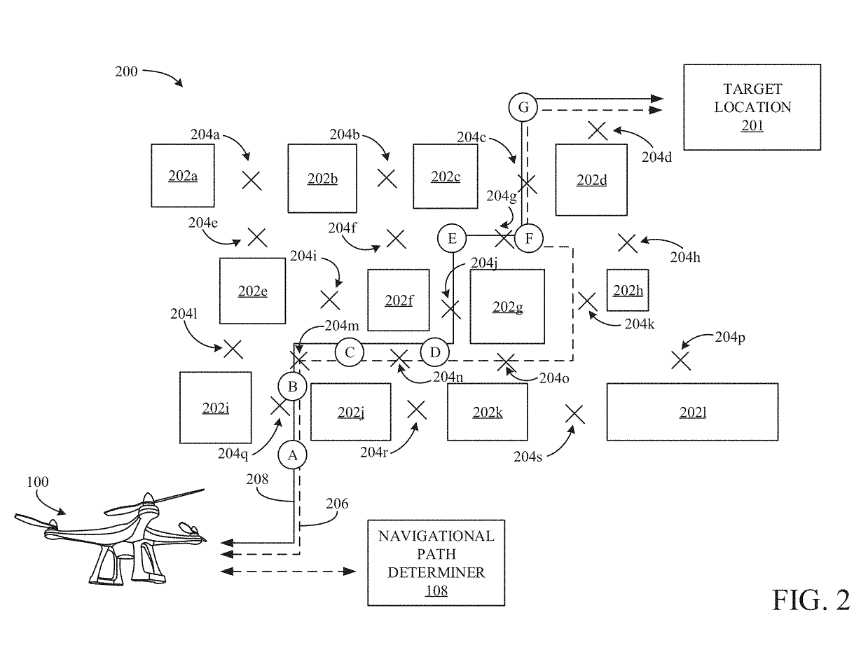

FIG. 2 is an example map 200 illustrating the flight of the example drone 100 to an example target location 201. The example map 200 includes the example drone 100 and the example navigational path determiner 108 of FIG. 1. The example map 200 further includes example structures 202a-1, example weather stations 204a-s, an example navigational path 206, and an example adjusted navigational path 208. The example structures 202a-1 represent the example structures 103 of FIG. 1 and the example weather stations 204a-s represent the example weather stations 102a-d of FIG. 1. Alternatively, the example weather stations 204a-s may be gateways (e.g., the example gateways 104a-c) that receive the weather data from individual weather stations and beacon or otherwise transmit data (e.g., the weather data, location data, etc.) that the example drone 100 may intercept.

As described above in conjunction with FIG. 1, the example navigational path determiner 108 gathers data from the example weather data aggregation server 106 (FIG. 1) to generate a navigational path (e.g., a pre-flight navigational path) to the target location 201. In the example map 200 of FIG. 2, the navigational path determiner 108 transmits the example navigational path 206 to the example drone 100 based on aggregated weather data corresponding to the example weather stations 204a-s.

When the example drone 100 of FIG. 2 navigates to the example target location 201 using the example navigational path 206, the example drone 100 intercepts weather data from each upcoming weather station within the navigational path 206. If the intercepted weather data includes undesired weather and/or undesired wind speeds, the example drone 100 intercepts weather data from neighboring weather sources (e.g., weather stations within a threshold range of the example drone 100) to adjust the navigational path 206. For example, at locations A, the example drone 100 intercepts the weather data from the example weather station 204q. In the illustrated map 200, the example drone 100 determines that the weather at the example weather stations 204q is not a danger region, and the drone 100 continues on the example navigational path 206. Similarly, the drone continues on the example navigational path 206 at location B and C. Alternatively, the example drone 100 may continuously intercept weather data (e.g., regardless of if the intercepted weather data from a weather source in the current path includes undesirable weather and/or undesirable wind speeds) from neighboring weather sources (e.g., weather stations within a threshold range of the example drone 100) as the drone 100 navigates.

At location D of FIG. 2, the example drone 100 intercepts the weather data from the example weather station 204o. In the illustrated example of FIG. 2, the example drone 100 determines that the wind speed is above a wind speed threshold and, thus, is a danger region. In response to determining that the region around the weather station 204o is a danger region, the example drone 100 intercepts weather data from neighboring weather stations within a threshold range of the location of the drone 100 (e.g., the example weather stations 204i, j, r). The drone 100 may adjust the example navigational path 206 in the direction of any of the weather stations whose weather data does not correspond to a danger region. In some examples, the drone 100 selects the direction that is closest to the direction of the example target location 201. In the illustrated example of FIG. 2, the drone 100 adjusts the navigational path 206, as shown in the example adjusted navigational path 208.

At location E of FIG. 2, the example drone 100 intercepts the weather data from the example weather station 204g. In the illustrated example of FIG. 2, the example drone 100 determines that the weather data from example weather station 204g does not correspond to a danger region and the example drone 100 joins the example navigational path 206 to reach the example target location 201 after location G.

FIG. 3 is a block diagram of the example navigational path determiner 108 of FIG. 1 disclosed herein, to determine a navigational path (e.g., the example navigational path 206 of FIG. 2) for the example drone 100 of FIGS. 1 and 2. While the example navigational path determiner 108 is described in conjunction with the example drone 100, the example navigational path determiner 108 may be utilized to determine navigational paths for any type of aerial vehicle. The example navigational path determiner 108 includes an example drone interface 300, an example path generator 302, an example path adjuster 304, an example location determiner 306, and an example server interface 308.

The example drone interface 300 of FIG. 3 interfaces with the example drone 100 of FIGS. 1 and/or 2. The example drone interface 300 transmits navigational paths (e.g., the example navigational path 206 and/or the example adjusted navigational path 208) to the example drone 100. Additionally, the navigational path determiner 108 receives locational data from the example drone 100 to identify the location of the example drone 100. In some examples, the drone interface 300 may receive weather data intercepted by the example drone 100 from a weather station that is not included in the network associated with the weather data aggregation server 106. In this manner, the example path adjuster 304 may utilize the additional weather data when adjusting a path for a second drone. In some examples, the drone interface 300 may receive weather data collected via one or more sensors of the example drone 100.

The example path generator 302 of FIG. 3 generates a navigational path (e.g., the example navigational path 206) to a target location (e.g., the example target location 201). In some examples, the path generator 302 determines the navigational path based on the closest distance between the example drone 100 and the example target location 201. In some examples, the path generator 302 determines the navigational path taking into account structures (e.g., the example structures 202a-1 of FIG. 2) that may impede the path of the example drone 100. In such examples, the path generator 302 selects the shortest path to the example target location 201 while avoiding contact with the example structures 202a-1.

The example path adjuster 304 of FIG. 3 adjusts the navigational path to avoid danger regions prior to sending the navigational plan to the example drone 100. The example path adjuster 304 identifies (e.g., flags) danger regions based on aggregated weather data from the example aggregated weather data aggregation server 106 (FIG. 1). Additionally, the example path adjuster 304 adjusts mid-flight navigational paths (e.g., the example adjusted navigational path 208 of FIG. 2) based on changes in the aggregated weather data that corresponds to danger regions within the navigational path.

The example location determiner 306 determines a location of the example drone 100 based on processing location data from the example drone 100. The example location determiner 306 may determine a location of the example drone 100 based on global positioning system coordinates of the example drone 100, location data transmitted to the example drone from an example weather station, and/or any other method of identifying location based on location information.

The example server interface 308 interfaces with the example weather data aggregation server 106 of FIG. 1. As described above, the example weather data aggregation server 106 aggregates weather data from multiple locations (e.g., weather stations and/or crowd-sourced weather data from mobile devices identified by users) and transmits the aggregated weather data to the example server interface 308. Additionally, the server interface 308 may interface with the weather data aggregation server 106 to continue to monitor weather data from one or more of the example weather stations 202a-1 while the example drone 100 of FIG. 1 travels to the example target location 201. Monitoring the one or more example weather stations 202a-1 allows the example path adjuster 304 to adjust the navigational path if the weather data from one or more of the weather stations 202a-1 corresponds to a danger region.

FIG. 4 is a block diagram of the example on-board controller 110 of FIG. 1, disclosed herein, to intercept weather data identified by weather stations (e.g., the example weather stations 102a-d of FIG. 1 and/or the example weather stations 203a-s of FIG. 2) and adjust a navigational path when the navigational path includes a danger region. While the example on-board controller 110 is described in conjunction with the example drone 100, the example on-board controller 110 may be utilized to control any type of aerial vehicle. The example on-board controller 110 includes one or more example interfaces 400, an example path follower 402, an example path adjuster 404, and an example location determiner 406.

The example interface(s) 400 of FIG. 4 interfaces with the example weather stations 102a-d, the example gateways 104a-c, the example navigational path determiner 108, and/or the example user 112. In some examples, the interface(s) 400 is a single interface capable of communicating to various devices (e.g., the example weather stations 102a-d, the example gateways 104a-c, the example navigational path determiner 108, and a remote control controlled by the example user 112). In some examples, the interface(s) 400 include multiple different interfaces, each interface capable of communicating with a particular device (e.g., a first interface to communicate with the example weather stations 102a-d, a second interface to communicate with the example gateways 102a-c, etc.). The example interface(s) 400 intercepts weather data from the example weather stations 102a-d and/or the example gateways 104a-c. The weather data may be wirelessly transmitted via a beacon, or other communication device, of the example weather stations 102a-d and/or the example gateways 104a-c. In some examples, the example interface(s) 400 receives weather data and/or wind speeds from a sensor embedded in or otherwise connected to the example drone 100.

Additionally, the example interface(s) 400 of FIG. 4 communicates with the example navigational path determiner 108 of FIGS. 1 and/or 2. In some examples, the interface(s) 400 receives navigational paths (e.g., pre-flight and/or adjusted navigational paths) from the example navigational path determine 108. In some examples, the interface(s) 400 transmits location data to the example navigational path determiner 108. In some examples, the interface(s) 400 communicate with the example user 112 via a remote controller. For example, when the user 112 interacts with the remote controller, the remote controller may transmit instructions to control the example drone 100. Additionally, the example interface(s) 400 may transmit a warning and/or override data to the user 112 via the remote control when the example drone 100 is heading toward a danger region.

The example path follower 402 of FIG. 4 navigates the example drone 100 according to the current navigational path and/or the instructions from the example user 112. In some examples, the path follower 402 adjusts the fight plan according to adjusted navigational paths via the example path adjuster 404 and/or the example navigational path determiner 108. The example path follower 402 navigates the example drone 100 by interfacing (e.g., communicating) with the mechanical components of the example drone 100 to control the flight (e.g., direction, speed, height, etc.) of the example drone 100.

The example path adjuster 404 of FIG. 4 processes weather data intercepted by the example interface(s) 400 to identify upcoming danger regions within a navigational path. As described above, a danger region corresponds to undesirable weather within a threshold distance of a weather station. For example, if the example path adjuster 404 identifies that the wind speed measured and/or identified by a weather station is above a wind speed threshold, the example path adjuster 404 determines that the region around the weather station is a danger region. In some examples, the example path adjuster 404 identifies natural disaster and/or other no fly zone data to determine if the region around the weather station is a danger region. The example path adjuster 404 adjusts the navigational path to avoid the determined danger region. The example path adjuster 404 processes weather data intercepted from neighboring weather stations to adjust the navigational path to avoid the danger region. In some examples, the path adjuster 404 generates an adjusted navigational path and instructs the example interface(s) 400 to transmit a warning to the example user 112 indicating the upcoming danger region and/or possible alternative navigational paths that do not include danger regions. In some examples, such as when an override mode is enabled, the example path adjuster 404 may override manual control of the example drone 100 to navigate the example drone 100 to a safe region.

The example location determiner 406 determines the location of the example drone 100 as the drone 100 navigates to a target location (e.g., the example target location 201). The location determiner 406 uses a positioning system to determine the location of the drone 100. For example, the location determiner 406 may have a global positioning system to determine location data of the example drone 100. Additionally or alternatively, the example location determiner 406 may utilize a local positioning system (e.g., Wi-Fi positioning system, cellular base station positioning system, radio broadcast positioning system, etc.) to determine location data of the example drone 100. Additionally or alternatively, the example location determiner 406 may determine location data of the example drone 100 via intercepted location data transmitted by the example weather stations 102a-d and/or the example gateway 104a-c. In some examples, the location determiner 406 uses the determined location to assist in a landing the drone 100. Additionally, the location determiner 406 may transmit the location of the example drone 100 to the example navigational path determiner 108 and/or the example user 112, periodically or aperiodically.

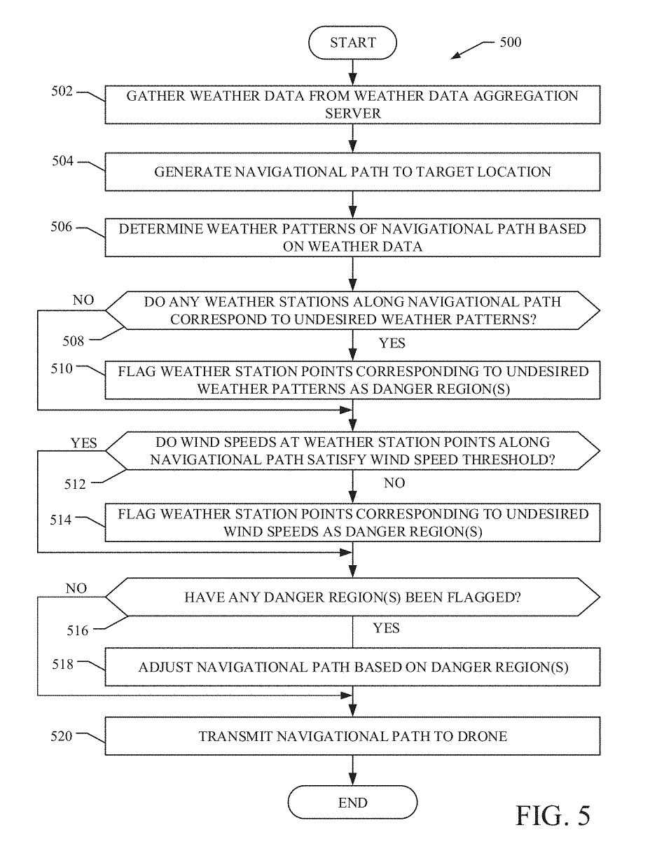

While example manners of implementing the example navigational path determiner 108 of FIG. 1 are illustrated in conjunction with FIG. 3 and example manners of implementing the example on-board controller 110 of FIG. 1 are illustrated in conjunction with FIG. 4, elements, processes and/or devices illustrated in conjunction with FIGS. 3 and 4 may be combined, divided, re-arranged, omitted, eliminated and/or implemented in any other way. Further, the example drone interface 300, the example path generator 302, the example path adjuster 304, the example location determiner 306, the example server interface 308, and/or, more generally, the example navigation path determiner 108 of FIG. 3 and the example interface(s) 400, the example path follower 402, the example path adjuster 404, the example location determiner 406, and/or, more generally, the example on-board controller 110 of FIG. 4 may be implemented by hardware, machine readable instructions, software, firmware and/or any combination of hardware, machine readable instructions, software and/or firmware. Thus, for example, any of the example drone interface 300, the example path generator 302, the example path adjuster 304, the example location determiner 306, the example server interface 308, and/or, more generally, the example navigation path determiner 108 of FIG. 3 and the example interface(s) 400, the example path follower 402, the example path adjuster 404, the example location determiner 406, and/or, more generally, the example on-board controller 110 of FIG. 4 could be implemented by analog and/or digital circuit(s), logic circuit(s), programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example drone interface 300, the example path generator 302, the example path adjuster 304, the example location determiner 306, the example server interface 308, and/or, more generally, the example navigation path determiner 108 of FIG. 3 and the example interface(s) 400, the example path follower 402, the example path adjuster 404, the example location determiner 406, and/or, more generally, the example on-board controller 110 of FIG. 4 is/are hereby expressly defined to include a tangible computer readable storage device or storage disk such as a memory, a digital versatile disk (DVD), a compact disk (CD), a Blu-ray disk, etc. storing the software and/or firmware. Further still, the example navigational path determiner 108 of FIG. 3 and/or the example on-board controller 110 of FIG. 4 include elements, processes and/or devices in addition to, or instead of, those illustrated in conjunction with FIGS. 5-8, and/or may include more than one of any or all of the illustrated elements, processes and devices.

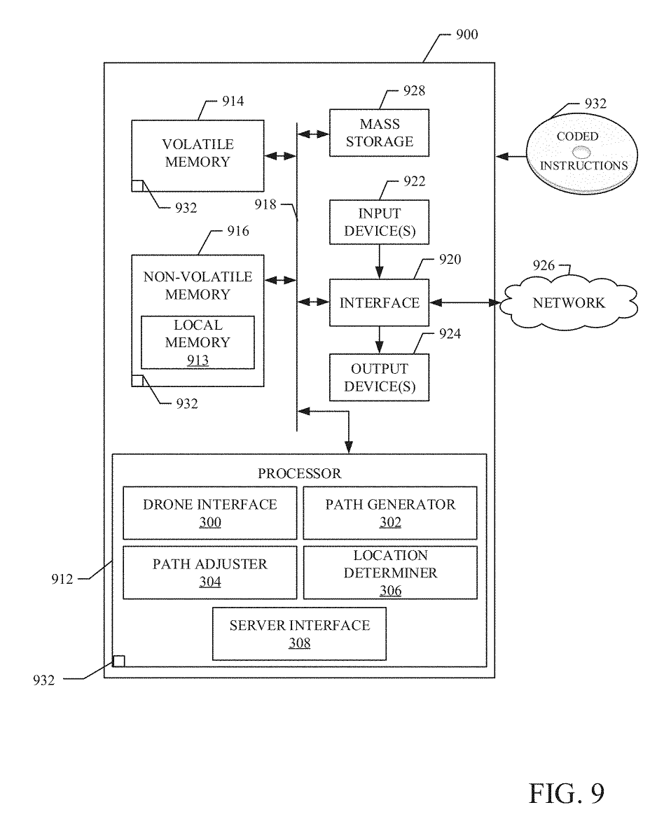

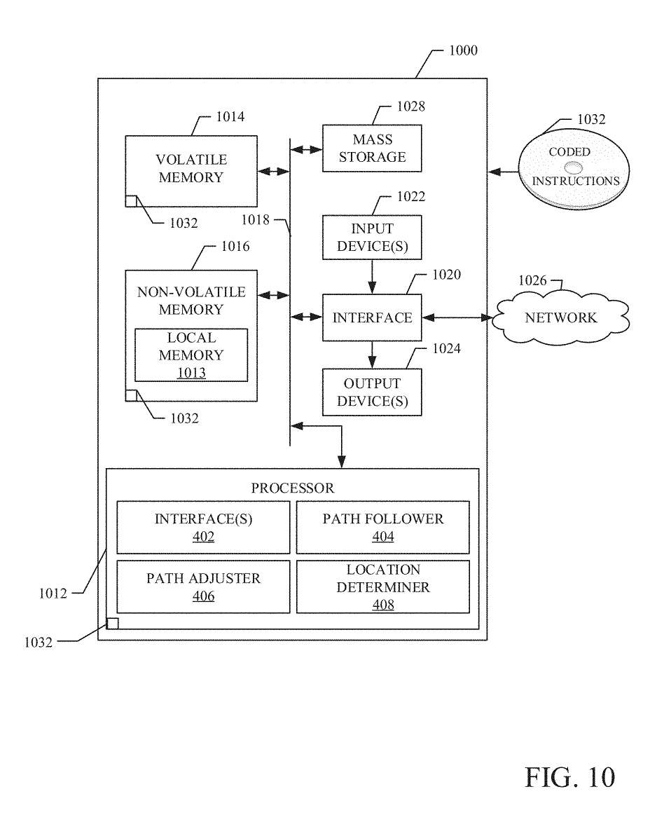

Flowcharts representative of example machine readable instructions for implementing the example navigational path determiner 108 of FIG. 3 and the example on-board controller 110 are shown in conjunction with FIGS. 5-8. In the examples, the machine readable instructions comprise a program for execution by a processor such as the processors 912, 1012 shown in the example processor platforms 900, 1000 discussed below in connection with FIGS. 9 and 10. The program may be embodied in machine readable instructions stored on a tangible computer readable storage medium such as a CD-ROM, a floppy disk, a hard drive, a digital versatile disk (DVD), a Blu-ray disk, or a memory associated with the processors 912, 1012, but the entire program and/or parts thereof could alternatively be executed by a device other than the processors 912, 1012 and/or embodied in firmware or dedicated hardware. Further, although the example program is described with reference to the flowcharts illustrated in conjunction with FIGS. 5-8, many other methods of implementing the example navigational path determiner 108 of FIG. 3 and/or the example on-board controller 110 of FIG. 4 may alternatively be used. For example, the order of execution of the blocks may be changed, and/or some of the blocks described may be changed, eliminated, or combined. Although the flowcharts of FIGS. 5-8 depict example operations in an illustrated order, these operations are not exhaustive and are not limited to the illustrated order. In addition, various changes and modifications may be made by one skilled in the art within the spirit and scope of the disclosure. For example, blocks illustrated in the flowchart(s) may be performed in an alternative order or may be performed in parallel.

As mentioned above, the example processes of FIGS. 5-8 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 5-8 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended. In addition, the term “including” is open-ended in the same manner as the term “comprising” is open-ended.

FIG. 5 is an example flowchart 500 representative of example machine readable instructions that may be executed to implement the example navigational path determiner 108 of FIG. 3 to generate and transmit a navigational path to the example drone 100 of FIGS. 1 and 2.

At block 502, the example server interface 308 gathers weather data from the example weather data aggregation server 106 of FIGS. 1 and 2. As described above, the example weather data aggregation server 106 aggregates weather data and/or other no fly zone data from multiple weather stations 102a-d, gateways 104a-c, drones with weather sensors, and/or any other source, to develop highly granular localized weather patterns. At block 504, the example path generator 302 generates a navigational path (e.g., a pre-flight navigational path) to a target location, such as the example target location 201 of FIG. 2. In some examples, the generated navigational path is the shortest distance from the current location of the drone 100 to the target location. In some examples, the generated navigational path is the shortest distance to the target location while taking into account structures (e.g., the example structures 103 of FIG. 1 and/or the example structures 202a-1 of FIG. 2). In such examples, the navigational path navigates around such structures to avoid collisions.

At bock 506, the example path adjuster 304 determines weather patterns along the generated navigational path based on the received weather data. For example, the path adjuster 304 may determine rain fall levels measured/identified by the example weather stations 102a-d along the generated navigational path. At block 508, the example path adjuster 304 determines if of the weather stations 102a-d along the generated navigational path correspond to undesired weather patterns (e.g., rain, snow, sleet, hail, etc.). If the example path adjuster 304 determines that one or more of the example weather stations 102a-d along the navigational path correspond to undesired weather patterns, the example path adjuster 304 flags the region(s) corresponding to the one or more weather stations 102a-d as danger region(s) (block 510).

At block 512, the example path adjuster 304 determines if the wind speeds along the generated navigational path satisfy a wind speed threshold (e.g., is below the wind speed threshold) based on the received weather data. For example, the path adjuster 304 may determine the wind speed measured/identified by the example weather stations 102a-d along the generated navigational path to determine if the wind speeds are too high (e.g., above the wind speed threshold) for safe travel of the example drone 100. If the example path adjuster 304 determines that the wind speeds measured/identified by one or more of the example weather stations 102a-d along the navigational path do not satisfy the wind speed threshold (e.g., are below the wind speed threshold), the example path adjuster 304 flags the region(s) corresponding to the one or more weather stations 102a-d as danger region(s) (block 514).

At block 516, the example path adjuster 304 determines if any danger regions have been flagged. If the example path adjuster 304 determines that one or more danger regions have been flagged, the example path adjuster 304 adjusts the navigational path based on the potential flagged danger region(s) (block 518). In some examples, the path adjuster 304 adjusts the navigational path based on the weather data identified by neighboring weather stations aggregated by the example weather data aggregation server 106 of FIG. 1. At block 520, the example drone interface 300 transmits the navigational path (e.g., adjusted or unadjusted) to the example drone 100.

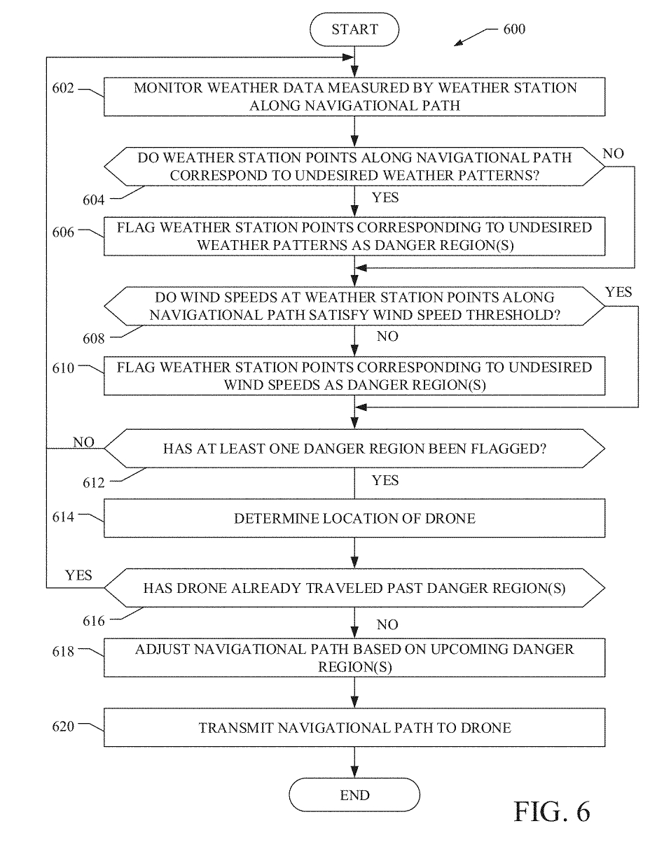

FIG. 6 is an example flowchart 600 representative of example machine readable instructions that may be executed to implement the example navigational path determiner 108 of FIG. 3 to adjust a navigational path of the example drone 100 of FIGS. 1 and 2 based on changes in weather.

At block 602, the example path adjuster 304 monitors weather data identified by the example weather stations 102a-d along the navigational path (e.g., within a threshold range of the navigational path) based on the weather data received by the server interface 308 from the example weather data aggregation server 106 of FIG. 1. Additionally, the example path adjuster 304 may monitor natural disaster and/or other no fly zones via the example weather data aggregation server 106. At block 604, the example path adjuster 304 determines if any of the weather stations 102a-d along the navigational path correspond to undesired weather patterns or other no fly zones (e.g., rain, snow, sleet, hail, etc.). If the example path adjuster 304 determines that one or more of the example weather stations 102a-d along the navigational path correspond to undesired weather patterns, the example path adjuster 304 flags the region(s) corresponding to the one or more weather stations 102a-d as danger region(s) (block 606).

At block 608, the example path adjuster 304 determines if the wind speeds along the navigational path satisfy a wind speed threshold (e.g., is below the wind speed threshold) based on the received weather data. For example, the path adjuster 304 may determine the wind speed identified by the example weather stations 102a-d along the navigational path to determine if the wind speeds are too high (e.g., above the wind speed threshold) for safe travel of the example drone 100. If the example path adjuster 304 determines that the wind speeds identified by one or more of the example weather stations 102a-d along the navigational path do not satisfy the wind speed threshold (e.g., are below the wind speed threshold), the example path adjuster 304 flags the region(s) corresponding to the one or more weather stations 102a-d as danger region(s) (block 610).

At block 612, the example path adjuster 304 determines if any danger regions have been flagged. If the example path adjuster 304 determines that one or more danger regions have not been flagged, the example path adjuster 304 continues to monitor weather data (block 602). If the example path adjuster 304 determines that one or more danger regions have been flagged, the example location determiner 306 determines a location of the example drone 100 (block 614). For example, the location determiner 306 may communicate with the drone 100 via the example drone interface 300 to receive the location of the example drone 100.

At block 616, the example path adjuster determines, based on the location of the example drone 100 and the navigational path, if the drone 100 has already traveled past the danger region(s). If the drone 100 has already traveled past the danger region(s), then the drone 100 is not in danger of heading into undesirable weather, and the path adjuster 304 continues to monitor weather data (block 602). If the drone 100 has not already traveled past the danger region(s), the example path adjuster 304 adjusts the navigational path based on the flagged upcoming danger region(s) (block 618). In some examples, the path adjuster 304 determines the navigational path based on the weather data identified by neighboring weather stations aggregated by the example weather data aggregation server 106 of FIG. 1. At block 620, the example drone interface 300 transmits the adjusted navigational path to the example drone 100.

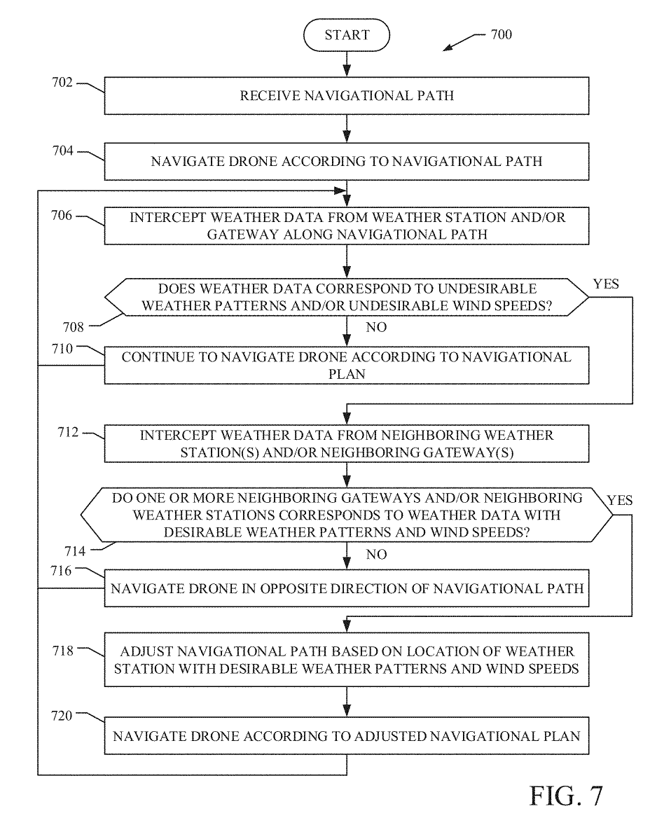

FIG. 7 is an example flowchart 700 representative of example machine readable instructions that may be executed to implement the example on-board controller 110 of FIG. 4 to adjust a navigational path of the example drone 100 of FIGS. 1 and 2 based on changes in weather.

At block 702, the example interface(s) 400 receives a navigational path from the example navigational path determiner 108 and/or the example user 112. Alternatively, if the example drone 100 is traveling fully autonomously, the navigational path may have been self-generated. At block 704, the example path follower 402 navigates the example drone 100 according to the navigational path. As described above in conjunction with FIG. 4, the example path follower 402 may control the mechanical components of the example drone 100 navigate the drone 100 according to the navigational path.

At block 706, the example interface(s) 400 intercepts weather data from the example weather stations 102a-d and/or the example gateways 104a-c along the navigational path (e.g., within a threshold distance of the navigational path). In this manner, the path adjuster 404 can identify a danger region prior to flying into the danger region. Additionally, the example interface(s) 400 may intercept no-fly zone data from any source to identify a danger region. At block 708, the example path adjuster 404 determines if the intercepted weather data corresponds to undesirable weather patterns and/or undesirable wind speeds. If the example path adjuster 404 determines that the weather data does not include undesirable weather patterns and/or undesirable wind speeds, the example path follower 402 continues to navigate the example drone 100 according to the current navigational plan (block 710). If the example path adjuster 404 determines that the weather data does not include undesirable weather patterns and/or undesirable wind speeds, the example interface(s) 400 intercepts weather data from neighboring weather station(s) and/or neighboring gateway(s) (block 712).

At block 714, the example path adjuster 404 determines if one or more of the neighboring weather stations and/or neighboring gateways correspond to weather data with desirable weather patterns (e.g., not raining, not snowing, etc.) and wind speeds (e.g., below the wind speed threshold). If the example path adjuster 404 determines that there are no neighboring weather stations and/or neighboring gateways corresponding to weather data with desirable weather patterns and wind speeds, the example path follower 402 navigates the example drone 100 back in the opposite direction of the current navigational path to attempt to return the drone 100 to a safe region (block 716). If the example path adjuster 404 determines that there are one or more neighboring weather stations and/or neighboring gateways corresponding to weather data with desirable weather patterns and wind speeds, the example path adjuster 404 adjusts the current navigational path based on the location of a weather station with desirable weather patterns and wind speeds (block 718). If there are multiple neighboring weather stations with desirable weather patterns and wind speeds, the example path adjuster 304 selects one of the neighboring weather stations to navigate toward. At block 720, the example path follower 402 navigates the example drone 100 according to the adjusted navigational plan.

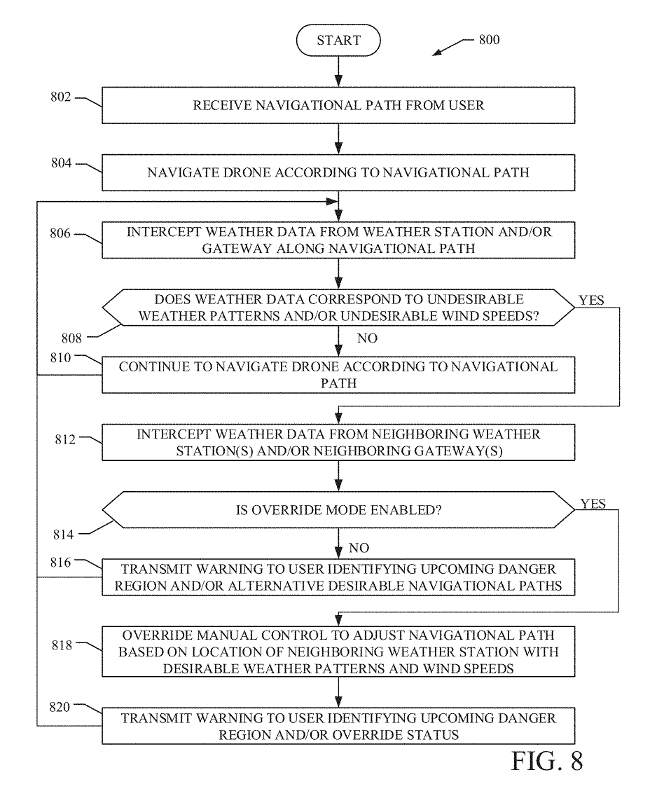

FIG. 8 is an example flowchart 800 representative of example machine readable instructions that may be executed to implement the example on-board controller 110 of FIG. 4 to warn a user controlling the example drone 100 (FIGS. 1 and 2) of a danger region and/or override the manual control to avoid the danger region.

At block 802, the example interface(s) 400 receives a navigational path from the example user 112 via a remote control. Alternatively, if the example drone 100 is in communication with the example user 112, but currently traveling fully autonomously, the navigational path may have been self-generated. At block 804, the example path follower 402 navigates the example drone 100 according to the navigational path. As described above in conjunction with FIG. 4, the example path follower 402 may control the mechanical components of the example drone 100 navigate the drone 100 according to the navigational path.

At block 806, the example interface(s) 400 intercepts weather data from the example weather stations 102a-d and/or the example gateways 104a-c along the navigational path. Additionally, the example interface(s) 400 may intercept no fly zone data from any source to identify a danger region. At block 808, the example path adjuster 404 determines if the intercepted weather data corresponds to undesirable weather patterns and/or undesirable wind speeds. If the example path adjuster 404 determines that the weather data does not include undesirable weather patterns and/or undesirable wind speeds, the example path follower 402 continues to navigate the example drone 100 according to the current navigational plan (block 810) and the example interface(s) 400 continues to intercept weather data during flight (block 806). If the example path adjuster 404 determines that the weather data does not include undesirable weather patterns and/or undesirable wind speeds, the example interface(s) 400 intercepts weather data from neighboring weather station(s) and/or neighboring gateway(s) (block 812).

At block 814, the example path adjuster 404 determines if an override mode is enabled. If the example path adjuster 404 determines that the override mode is not enabled, the example interface(s) 400 transmits a warning to the user 112 via the remote control identifying the upcoming danger region and/or alternative desirable navigational paths that would avoid the danger region (block 816). If the example path adjuster 404 determines that the override mode is enabled, the example path adjuster 404 overrides manual control of the user 112 to adjust the navigational path based on the location of a neighboring weather station with desirable weather patterns and wind speeds. At block 820, the example interface(s) 400 transmits a warning to the user 112 via the remote control identifying the upcoming danger region and/or an override status. The override status may indicate that the example drone 100 has been overridden and details related to the override.

FIG. 9 is a block diagram of an example processor platform 900 capable of executing the instructions of FIGS. 5 and 6 to implement the example navigational path determiner 108 of FIG. 2. The processor platform 900 can be, for example, a server, a personal computer, a mobile device (e.g., a cell phone, a smart phone, a tablet such as an iPad™), a personal digital assistant (PDA), an Internet appliance, or any other type of computing device.

The processor platform 900 of the illustrated example includes a processor 912. The processor 912 of the illustrated example is hardware. For example, the processor 912 can be implemented by integrated circuits, logic circuits, microprocessors or controllers from any desired family or manufacturer.

The processor 912 of the illustrated example includes the example memory 913 (e.g., a cache). The example processor 912 of FIG. 9 executes the instructions of FIGS. 5 and 6 to implement the example drone interface 300, the example path generator 302, the example path adjuster 304, the example location determiner 306, and/or the example server interface 308 of FIG. 3 to implement the example navigational path determiner 108 (FIG. 1). The processor 912 of the illustrated example is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAIVIBUS Dynamic Random Access Memory (RDRAM) and/or any other type of random access memory device. The non-volatile memory 916 may be implemented by flash memory and/or any other desired type of memory device. Access to the main memory 914, 916 is controlled by a memory controller.

The processor platform 900 of the illustrated example also includes an interface circuit 920. The interface circuit 920 may be implemented by any type of interface standard, such as an Ethernet interface, a universal serial bus (USB), and/or a PCI express interface.

In the illustrated example, one or more input devices 922 are connected to the interface circuit 920. The input device(s) 922 permit(s) a user to enter data and commands into the processor 912. The input device(s) can be implemented by, for example, a sensor, a microphone, a camera (still or video), a keyboard, a button, a mouse, a touchscreen, a track-pad, a trackball, isopoint and/or a voice recognition system.

One or more output devices 924 are also connected to the interface circuit 920 of the illustrated example. The output devices 924 can be implemented, for example, by display devices (e.g., a light emitting diode (LED), an organic light emitting diode (OLED), a liquid crystal display, a cathode ray tube display (CRT), a touchscreen, a tactile output device, and/or speakers). The interface circuit 920 of the illustrated example, thus, typically includes a graphics driver card, a graphics driver chip or a graphics driver processor.

The interface circuit 920 of the illustrated example also includes a communication device such as a transmitter, a receiver, a transceiver, a modem and/or network interface card to facilitate exchange of data with external machines (e.g., computing devices of any kind) via a network 926 (e.g., an Ethernet connection, a digital subscriber line (DSL), a telephone line, coaxial cable, a cellular telephone system, etc.).

The processor platform 900 of the illustrated example also includes one or more mass storage devices 928 for storing software and/or data. Examples of such mass storage devices 928 include floppy disk drives, hard drive disks, compact disk drives, Blu-ray disk drives, RAID systems, and digital versatile disk (DVD) drives.

The coded instructions 932 of FIGS. 5 and 6 may be stored in the mass storage device 928, in the volatile memory 914, in the non-volatile memory 916, and/or on a removable tangible computer readable storage medium such as a CD or DVD.

FIG. 10 is a block diagram of an example processor platform 1000 capable of executing the instructions of FIGS. 7 and 8 to implement the example on-board controller 110 of FIG. 1. The processor platform 1000 can be, for example, a server, a personal computer, a mobile device (e.g., a cell phone, a smart phone, a tablet such as an iPad™), a personal digital assistant (PDA), an Internet appliance, or any other type of computing device.

The processor platform 1000 of the illustrated example includes a processor 1012. The processor 1012 of the illustrated example is hardware. For example, the processor 1012 can be implemented by integrated circuits, logic circuits, microprocessors or controllers from any desired family or manufacturer.

The processor 1012 of the illustrated example includes the example memory 1013 (e.g., a cache). The example processor 1012 of FIG. 10 executes the instructions of FIGS. 7 and 8 to implement the example interface(s) 400, the example path follower 402, the example path adjuster 404, and/or the example location determiner 408 of FIG. 4 to implement the example on-board controller 110 (FIG. 1). The processor 1012 of the illustrated example is in communication with a main memory including a volatile memory 1014 and a non-volatile memory 1016 via a bus 1018. The volatile memory 1014 may be implemented by Synchronous Dynamic Random Access Memory (SDRAM), Dynamic Random Access Memory (DRAM), RAIVIBUS Dynamic Random Access Memory (RDRAM) and/or any other type of random access memory device. The non-volatile memory 1016 may be implemented by flash memory and/or any other desired type of memory device. Access to the main memory 1014, 1016 is controlled by a memory controller.

The processor platform 1000 of the illustrated example also includes an interface circuit 1020. The interface circuit 1020 may be implemented by any type of interface standard, such as an Ethernet interface, a universal serial bus (USB), and/or a PCI express interface.

In the illustrated example, one or more input devices 1022 are connected to the interface circuit 1020. The input device(s) 1022 permit(s) a user to enter data and commands into the processor 1012. The input device(s) can be implemented by, for example, a sensor, a microphone, a camera (still or video), a keyboard, a button, a mouse, a touchscreen, a track-pad, a trackball, isopoint and/or a voice recognition system.

One or more output devices 1024 are also connected to the interface circuit 1020 of the illustrated example. The output devices 1024 can be implemented, for example, by display devices (e.g., a light emitting diode (LED), an organic light emitting diode (OLED), a liquid crystal display, a cathode ray tube display (CRT), a touchscreen, a tactile output device, and/or speakers). The interface circuit 1020 of the illustrated example, thus, typically includes a graphics driver card, a graphics driver chip or a graphics driver processor.

The interface circuit 1020 of the illustrated example also includes a communication device such as a transmitter, a receiver, a transceiver, a modem and/or network interface card to facilitate exchange of data with external machines (e.g., computing devices of any kind) via a network 1026 (e.g., an Ethernet connection, a digital subscriber line (DSL), a telephone line, coaxial cable, a cellular telephone system, etc.).

The processor platform 1000 of the illustrated example also includes one or more mass storage devices 1028 for storing software and/or data. Examples of such mass storage devices 1028 include floppy disk drives, hard drive disks, compact disk drives, Blu-ray disk drives, RAID systems, and digital versatile disk (DVD) drives.

The coded instructions 1032 of FIGS. 7 and 8 may be stored in the mass storage device 1028, in the volatile memory 1014, in the non-volatile memory 1016, and/or on a removable tangible computer readable storage medium such as a CD or DVD.

Example 1 is a method for adjusting a flight path of a drone, the method comprising, navigating, via a processor of a drone, according to a flight path; Example 1 also includes intercepting, via the processor of the drone, weather data identified by a weather source within a threshold range of the flight path. Example 1 also includes when the weather data corresponds to undesirable weather data, adjusting, via the processor of the drone, the flight path to avoid a region corresponding to the weather source.

Example 2 includes the subject matter of example 1, wherein weather data is intercepted from at least one of the weather source or a gateway associated with the weather source.

Example 3 includes the subject matter of example 2, wherein the weather data is wirelessly transmitted from at least one of the weather source or the gateway associated with the weather source.

Example 4 includes the subject matter of examples 1 or 2, wherein the weather data is intercepted prior to navigating within the region corresponding to the weather source.

Example 5 includes the subject matter of example 1, wherein undesirable weather data includes at least one of rain, snow, sleet, hail, or wind speeds above a threshold speed.

Example 6 includes the subject matter of examples 1, 2 or 5, wherein the weather data identified by the weather source corresponds to highly granular weather data within the region corresponding to the weather source.

Example 7 includes the subject matter of example 1, wherein adjusting the flight path includes intercepting additional weather data identified by neighboring weather sources, and when second weather data identified by a second weather source of the neighboring weather sources corresponds to desirable weather data, adjusting the flight path to navigate toward a second region corresponding to the second weather source.

Example 8 includes the subject matter of example 7, further including, when none of the additional weather data corresponds to desirable weather data, adjusting the flight path to return to a previous location of the flight path.

Example 9 includes the subject matter of examples 1 or 8, further including, navigating the drone according to the adjusted flight path.

Example 10 is a method for identifying undesirable weather in a flight path of a drone, the method comprising navigating, via a processor of a drone, according to a flight path. Example 10 also includes intercepting, via the processor of the drone, weather data identified by a weather source within a threshold range of the flight path. Example 10 also includes when the weather data corresponds to undesirable weather data, transmitting, via the processor of the drone, a warning identifying the undesirable weather data.

Example 11 includes the subject matter of example 10, wherein the warning is transmitted to a remote control device.

Example 12 includes the subject matter of example 11, wherein a user controls the remote control device to provide the flight path to the drone.

Example 13 includes the subject matter of example 12, further including overriding instructions provided by the remote control device to adjust the flight path to avoid a region corresponding to the weather source.

Example 14 includes the subject matter of example 10, wherein weather data is intercepted from at least one of the weather source or a gateway associated with the weather source.

Example 15 includes the subject matter of example 14, wherein the weather data is wirelessly transmitted from at least one of the weather source or the gateway associated with the weather source.

Example 16 includes the subject matter of examples 10, 13, or 15, wherein the weather data is intercepted prior to navigating within a region corresponding to the weather source.

Example 17 includes the subject matter of examples 10, 13, or 15, wherein undesirable weather data includes at least one of rain, snow, sleet, hail, or wind speeds above a threshold speed.

Example 18 includes the subject matter of examples 10, 13, or 15, wherein the weather data identified by the weather source corresponds to highly granular weather data within a region corresponding to the weather source.

Example 19 is an apparatus for adjusting a flight path of a drone, the apparatus comprising a path follower to navigate according to a flight path. Example 19 also includes an interface to intercept weather data identified by a weather source within a threshold range of the flight path. Example 19 also includes a path adjuster to, when the weather data corresponds to undesirable weather data, adjust the flight path to avoid a region corresponding to the weather source.

Example 20 includes the subject matter of example 19, wherein the interface is to intercept weather data from at least one of the weather source or a gateway associated with the weather source.

Example 21 includes the subject matter of example 20, wherein the weather data is wirelessly transmitted from at least one of the weather source or the gateway associated with the weather source.

Example 22 includes the subject matter of examples 19 or 20, wherein the interface is to intercept the weather data prior to navigating within the region corresponding to the weather source.

Example 23 includes the subject matter of example 19, wherein undesirable weather data includes at least one of rain, snow, sleet, hail, or wind speeds above a threshold speed.

Example 24 includes the subject matter of examples 19, 20, or 23, wherein the weather data identified by the weather source corresponds to highly granular weather data within the region corresponding to the weather source.

Example 25 includes the subject matter of example 19, wherein the path adjuster is to adjusting the flight path by intercepting additional weather data identified by neighboring weather sources; and when second weather data identified by a second weather source of the neighboring weather sources corresponds to desirable weather data, adjusting the flight path to navigate toward a second region corresponding to the second weather source.

Example 26 includes the subject matter of example 25, wherein the path adjuster is to, when none of the additional weather data corresponds to desirable weather data, adjust the flight path to return to a previous location of the flight path.

Example 27 includes the subject matter of example 19 or 26, wherein the path follower is to navigate the drone according to the adjusted flight path.

Example 28 is an apparatus for identifying undesirable weather in a flight path of a drone, the apparatus comprising a path follower to navigate according to a flight path. Example 28 also includes an interface to intercept weather data identified by a weather source within a threshold range of the flight path; and when the weather data corresponds to undesirable weather data, transmit a warning identifying the undesirable weather data.

Example 29 includes the subject matter of example 28, wherein the interface is to transmit the warning to a remote control device.

Example 30 includes the subject matter of example 29, wherein a user controls the remote control device to provide the flight path to the drone.

Example 31 includes the subject matter of example 30, further including a path follower to override instructions provided by the remote control device to adjust the flight path to avoid a region corresponding to the weather source.

Example 32 includes the subject matter of example 28, wherein the interface is to intercept the weather data from at least one of the weather source or a gateway associated with the weather source.

Example 33 includes the subject matter of example 32, wherein the weather data is wirelessly transmitted from at least one of the weather source or the gateway associated with the weather source.

Example 34 includes the subject matter of examples 28, 31, or 33, wherein the interface is to intercept the weather data prior to navigating within a region corresponding to the weather source.

Example 35 includes the subject matter of examples 28, 31, or 33, wherein undesirable weather data includes at least one of rain, snow, sleet, hail, or wind speeds above a threshold speed.

Example 36 includes the subject matter of examples 28, 31, or 33, wherein the weather data identified by the weather source corresponds to highly granular weather data within a region corresponding to the weather source.

Example 37 is a tangible computer readable medium comprising instructions which, when executed cause a machine to at least navigate according to a flight path. intercept weather data identified by a weather source within a threshold range of the flight path, and when the weather data corresponds to undesirable weather data, adjust the flight path to avoid a region corresponding to the weather source.

Example 38 includes the subject matter of example 37, wherein the instructions, when executed, cause the machine to intercept weather data from at least one of the weather source or a gateway associated with the weather source.

Example 39 includes the subject matter of example 38, wherein the weather data is wirelessly transmitted from at least one of the weather source or the gateway associated with the weather source.

Example 40 includes the subject matter of examples 37 or 38, wherein the instructions, when executed, cause the machine to intercept the weather data prior to navigating within the region corresponding to the weather source.

Example 41 includes the subject matter of example 37, wherein undesirable weather data includes at least one of rain, snow, sleet, hail, or wind speeds above a threshold speed.

Example 42 includes the subject matter of examples 37, 38, or 41, wherein the weather data identified by the weather source corresponds to highly granular weather data within the region corresponding to the weather source.

Example 43 includes the subject matter of example 37, wherein the instructions, when executed, cause the machine adjust to intercept additional weather data identified by neighboring weather sources; and when second weather data identified by a second weather source of the neighboring weather sources corresponds to desirable weather data, adjust the flight path to navigate toward a second region corresponding to the second weather source.

Example 44 includes the subject matter of example 43, wherein the instructions, when executed, cause the machine to, when none of the additional weather data corresponds to desirable weather data, adjust the flight path to return to a previous location of the flight path.

Example 45 includes the subject matter of examples 37 or 44, wherein the instructions, when executed, cause the machine to navigate the drone according to the adjusted flight path.

Example 46 is a tangible computer readable medium comprising instructions which, when executed, cause a machine to at least navigate according to a flight path, intercept weather data identified by a weather source within a threshold range of the flight path, and when the weather data corresponds to undesirable weather data, transmit a warning identifying the undesirable weather data.

Example 47 includes the subject matter of example 46, wherein the instructions, when executed, cause the machine to transmit the warning to a remote control device.

Example 48 includes the subject matter of example 47, wherein a user controls the remote control device to provide the flight path to the drone.

Example 49 includes the subject matter of example 48, wherein the instructions, when executed, cause the machine to override instructions provided by the remote control device to adjust the flight path to avoid a region corresponding to the weather source.

Example 50 includes the subject matter of example 46, wherein the instructions, when executed, cause the machine to intercept the weather data from at least one of the weather source or a gateway associated with the weather source.

Example 51 includes the subject matter of example 50, wherein the weather data is wirelessly transmitted from at least one of the weather source or the gateway associated with the weather source.

Example 52 includes the subject matter of examples 46, 49, or 51, wherein the instructions, when executed, cause the machine to intercept the weather data prior to navigating within a region corresponding to the weather source.

Example 53 includes the subject matter of examples 46, 49, or 51, wherein undesirable weather data includes at least one of rain, snow, sleet, hail, or wind speeds above a threshold speed.

Example 54 includes the subject matter of examples 46, 49, or 51, wherein the weather data identified by the weather source corresponds to highly granular weather data within a region corresponding to the weather source.

Example 55 is an apparatus for adjusting a flight path of a drone, the apparatus comprising a first means to navigate according to a flight path. Example 55 also includes a second means to intercept weather data identified by a weather source within a threshold range of the flight path. Examples 55 also includes a third means to, when the weather data corresponds to undesirable weather data, adjust the flight path to avoid a region corresponding to the weather source.

Example 56 includes the subject matter of example 55, wherein the second means is to intercept weather data from at least one of the weather source or a gateway associated with the weather source.

Example 57 includes the subject matter of example 56, wherein the weather data is wirelessly transmitted from at least one of the weather source or the gateway associated with the weather source.

Example 58 includes the subject matter of examples 55 or 56, wherein the second means is to intercept the weather data prior to navigating within the region corresponding to the weather source.

Example 59 includes the subject matter of example 55, wherein undesirable weather data includes at least one of rain, snow, sleet, hail, or wind speeds above a threshold speed.

Example 60 includes the subject matter of examples 55, 56, or 59, wherein the weather data identified by the weather source corresponds to highly granular weather data within the region corresponding to the weather source.

Example 61 includes the subject matter of example 55, wherein the third means is to adjusting the flight path by intercepting additional weather data identified by neighboring weather sources; and when second weather data identified by a second weather source of the neighboring weather sources corresponds to desirable weather data, adjusting the flight path to navigate toward a second region corresponding to the second weather source.

Example 62 includes the subject matter of example 61, wherein the third means is to, when none of the additional weather data corresponds to desirable weather data, adjust the flight path to return to a previous location of the flight path.

Example 63 includes the subject matter of examples 55 or 61, wherein the first means is to navigate the drone according to the adjusted flight path.

Example 64 is an apparatus for identifying undesirable weather in a flight path of a drone, the apparatus comprising a first means to navigate according to a flight path. Example 64 also includes a second means to intercept weather data identified by a weather source within a threshold range of the flight path; and when the weather data corresponds to undesirable weather data, transmit a warning identifying the undesirable weather data.

Example 65 includes the subject matter of example 64, wherein the second means is to transmit the warning to a remote control device.

Example 66 includes the subject matter of example 65, wherein a user controls the remote control device to provide the flight path to the drone.

Example 67 includes the subject matter of example 66, further including a third means to override instructions provided by the remote control device to adjust the flight path to avoid a region corresponding to the weather source.

Example 68 includes the subject matter of example 64, wherein the second means is to intercept the weather data from at least one of the weather source or a gateway associated with the weather source.

Example 69 includes the subject matter of example 68, wherein the weather data is wirelessly transmitted from at least one of the weather source or the gateway associated with the weather source.

Example 70 includes the subject matter of examples 64, 67, or 69, wherein the second means is to intercept the weather data prior to navigating within a region corresponding to the weather source.

Example 71 includes the subject matter of examples 64, 67, or 69, wherein undesirable weather data includes at least one of rain, snow, sleet, hail, or wind speeds above a threshold speed.

Example 72 includes the subject matter of examples 64, 67, or 69, wherein the weather data identified by the weather source corresponds to highly granular weather data within a region corresponding to the weather source.

From the foregoing, it will be appreciated that the above disclosed methods, apparatus, and articles of manufacture may be used to navigate drones away from dangerous weather conditions using crowd sourced local weather stations. Conventional techniques of navigating drones away from dangerous weather conditions include monitoring weather conditions using a base station. However, such conventional techniques may not be able to identify dangerous weather conditions with enough granularity to prevent a drone from traveling into a danger region. Additionally, when the drone loses communication with the base station, the drone is completely unprotected against dangerous weather. Examples disclosed herein alleviate such problems by intercepting weather data from weather stations locally at the drone. In this manner, the drone is able to identify danger regions with high granularity independent of a base station. Additionally, examples disclosed herein are about to protect a drone being manually controlled by user by warning the user of an upcoming danger region and/or overriding the manual control to navigate the drone to a safety region.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

1. A method for adjusting a flight path of a drone, the method comprising:
navigating, by executing an instruction with a processor of a drone, according to a flight path provided by a user;
obtaining, by executing an instruction with the processor of the drone, weather data from a weather source within a threshold range of the flight path; and
when the weather data corresponds to undesirable weather data, providing a warning to the user, the warning identifying the undesirable weather data.

2. The method of claim 1, wherein the weather data is obtained by intercepting the weather data from at least one of the weather source or a gateway associated with the weather source.

3. The method of claim 2, wherein the weather data is wirelessly transmitted from at least one of the weather source or the gateway associated with the weather source.

4. The method of claim 2, wherein the weather data is intercepted prior to navigating the drone into a region corresponding to the weather source.

5. The method of claim 1, wherein the undesirable weather data includes at least one of rain, snow, sleet, hail, or wind speeds above a threshold speed.

6. The method of claim 1, wherein the weather data from the weather source corresponds to highly granular weather data within a region corresponding to the weather source.

7. The method of claim 1, wherein the adjusting of the flight path includes:
intercepting additional weather data from neighboring weather sources;
when second weather data from at least one of the neighboring weather sources corresponds to desirable weather data, adjusting the flight path to navigate the drone toward a second region corresponding to the second weather data;
when none of the additional weather data corresponds to desirable weather data, at least one of maintaining the flight path or adjusting the flight path to return to a previous location of the flight path; and
navigating the drone according to the at least one of the maintained flight path or the adjusted flight path.

8. (canceled)

9. (canceled)

10. An apparatus to control a flight path of a drone, the apparatus comprising:
a path follower to navigate according to a flight path provided by a user; and
an interface to:
obtain weather data from a weather source within a threshold range of the flight path; and
when the weather data includes undesirable weather data, transmit a warning identifying the undesirable weather data to the user.

11. The apparatus of claim 10, wherein the interface is to obtain the weather data by intercepting the weather data from at least one of the weather source or a gateway associated with the weather source.

12. The apparatus of claim 11, wherein the interface is to obtain the weather data by wirelessly receiving the weather data from at least one of the weather source or the gateway associated with the weather source.

13. The apparatus of claim 11, wherein the interface is to intercept the weather data prior to navigating within a region corresponding to the weather source.

14. The apparatus of claim 10, wherein the undesirable weather data includes at least one of rain, snow, sleet, hail, or wind speeds above a threshold speed.

15. The apparatus of claim 10, wherein the weather data from the weather source corresponds to highly granular weather data within a region corresponding to the weather source.

16. The apparatus of claim 10, wherein:
the interface is to intercept additional weather data from neighboring weather sources; and further including a path adjustor to:
when second weather data from at least one of the neighboring weather sources corresponds to desirable weather data, adjust the flight path to navigate toward a second region corresponding to the second weather data; and
when none of the additional weather data corresponds to desirable weather data, at least one of maintain the flight path or adjust the flight path to return to a previous location of the flight path; and
the path follower to navigate the drone according to the at least one of the maintained flight path or the adjusted flight path.

17. (canceled)

18. (canceled)

19. A tangible computer readable storage medium comprising instructions which, when executed, cause a machine to at least:
navigate according to a flight path;
obtain weather data from a weather source within a threshold range of the flight path; and
when the weather data corresponds to undesirable weather data, provide a warning to a user, the warning identifying the undesirable weather data.

20. The tangible computer readable storage medium of claim 19, wherein the instructions, when executed, cause the machine to obtain the weather data by intercepting the weather data from at least one of the weather source or a gateway associated with the weather source.

21. The apparatus of claim 10, wherein the interface is to transmit the warning to a remote control device.

22. The apparatus of claim 21, wherein the interface receives the flight path from the remote control device.

23. The apparatus of claim 22, further including a path adjuster to override instructions provided by the remote control device to adjust the flight path to avoid a region corresponding to the weather source.

24. The tangible computer readable storage medium of claim 19, wherein the instructions, when executed, cause the machine to provide the warning by transmitting the warning to a remote control device.
